(19) United States
(12) Patent Application Publication
(10) Pub. No.: US 2007/0254682 A1
(43) Pub. Date: Nov. 1, 2007

(54) Method for determining if a caller is permitted to leave a message in a mailbox

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/412,611

(22) Filed: Apr. 27, 2006

(51) Int. Cl. H04Q 7/20

(52) U.S. Cl. 455/466

(57) ABSTRACT

The present invention provides a method for determining if a caller is allowed to leave a message in a mailbox. A call request for a called phone is received from a caller at a message server. The message server determines if the called phone has subscribed to a message administration service. If so, the message server determines if the caller is allowed to leave a message in a mailbox. This can be accomplished by either determining if the caller has entered a valid personal identification number or determining if the name of the caller is in a list of pre-approved names. If the caller is allowed to leave a message in a mailbox, the message server allows the caller to leave a message in a mailbox in a mailbox associated with the called phone.

### FIELD OF THE INVENTION

The present invention relates generally to communication systems, and more particularly to messaging systems.

### BACKGROUND OF THE INVENTION

Mobile units, such as cell phones, allow users to place and receive calls from diverse geographic locations. A subscriber using a mobile unit is able to place and receive calls outside of the home cellular network. This ability, known as roaming, greatly expands the usefulness of mobile units.

Often mobile service providers charge a higher amount for roaming than for mobile units who are subscribed to their network. These fees can include roaming charges and a higher per-minute rate for any time used on the network. In typical cellular networks, subscribers are charged not only for calls placed from their mobile unit, but also for calls received by their mobile unit.

One problem with such arrangements is that subscribers can be charged for incoming calls from callers that the subscriber does not want to talk to. This can lead to charges for unwanted calls. Further, some wireless systems bill for roaming charges and per-minute fees when a voice mail message is left in a mailbox when the user is outside of the home wireless communication system. This fee is charged whether or not the subscriber ever retrieves or listens to the voice mail message.

Therefore, a need exists for a method of preventing excess charges from accruing on a mobile unit's account, especially while the mobile unit is roaming.

### BRIEF SUMMARY OF THE INVENTION

The present invention provides a method that allows a subscriber to customize a messaging service so that only those with predetermined access can leave a message for the subscriber in a mailbox associated with the subscriber.

In accordance with an exemplary embodiment of the present invention, a mobile unit subscribes to a customized voice message administration service. The customized voice message administration service receives from the subscriber information for identifying callers who are permitted to leave messages during the registration process. The customized voice message administration service preferably resides on a message server, which can be a standalone component of a communication system or can be embedded within a controlling entity, such as a Mobile Switching Center (MSC) in a wireless communication system.

One type of identification information stored by the message server is a personal identification number (PIN). The message server receives the PIN from the subscriber, preferably during the registration process.

A second type of identification information stored by the message server is a list of message-allowed caller names. The names are preferably spoken by a user of the subscribing mobile unit and stored by the message server. The names can be entered by any other appropriate method, such as keypad entry, online registration, or operator assistance.

Once subscribed to the customized voice message administration service, a user of the subscribed mobile unit can activate or deactivate the service. For example, the user can activate the service when traveling to an area outside of the home cellular network, such as when traveling internationally. The activation an deactivation can also happen automatically, so that when the mobile unit moves to a cellular system outside of their home network, the service is automatically turned on. The service would then be automatically turned off upon returning to the home cellular network.

In an exemplary embodiment, a call request arrives for a mobile unit while the mobile unit is unavailable. For example, the mobile unit may be involved in another call, may be powered off, may be out of a usable service area, or the call request may simply be being ignored. The MSC or other entity processing the call request sends the call request to a messaging server associated with the mobile unit.

The message server determines if the called mobile unit subscribes to the customized voice message administration service. If the mobile unit does not subscribe to the service, the message server allows the caller to leave a message in a mailbox associated with the mobile unit.

If the mobile unit has subscribed to the customized voice message administration service, the message server determines if the caller is allowed to leave a message for the called mobile unit. One way the message server can determine if the caller is allowed to leave a message for the called mobile unit is to receive a PIN from the caller. If the PIN entered by the caller matches the PIN stored by the called mobile unit, the message server allows the caller to leave a message for the mobile unit.

A second method for determining if the caller is allowed to leave a message for the called mobile unit is to determine if the caller is one of the names on the list of message-allowed caller names. The message server preferably prompts the caller to announce their name. Upon receiving the caller's name, the message server determines if the caller's name is in the message-allowed caller names list. If the caller's name is in the list, indicating that the caller is allowed to leave a message in their mailbox, the message server allows the caller to leave a message in the mailbox associated with the called mobile unit.

If the caller either does not have the PIN or their name is not in the message-allowed caller names list, the caller is denied the ability to leave a message for the called mobile unit. In this case, the message server plays an announcement to the caller telling the caller that the caller is not allowed to leave a message in the mailbox associated with the mobile unit. After playing the announcement to the caller, the message server informs the MSC to drop the call.

The present invention thereby allows a mobile subscriber to control roaming charges and prevent unnecessary interruptions while roaming, such as when on vacation, while at the same time having the convenience of calling and receiving calls from friends and relatives when away from their home cellular network.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for registering a mobile unit to a customized messaging service in accordance with an exemplary embodiment of the present invention.

FIG. 3 depicts a flowchart of a method for processing a call request by a message server in accordance with an exemplary embodiment of the present invention.

### DETAILED DESCRIPTION OF THE INVENTION

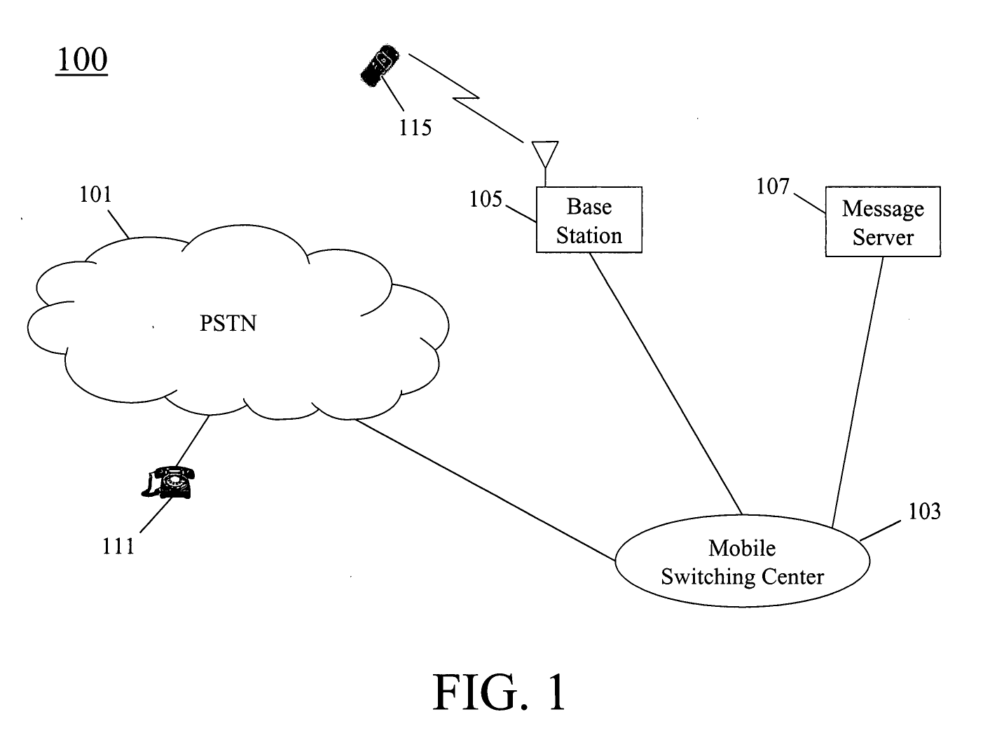

FIG. 1 depicts a communication system 100 in accordance with an exemplary embodiment of the present invention. Communication system 100 includes Public Switched Telephone Network (PSTN) 101, Mobile Switching Center (MSC) 103, base station 105, and Message Server 107.

PSTN 101 is an international telephone network that provides telephony service to users connected to PSTN 101. Customer Premises Equipment (CPE) 111 is coupled to communication system 100 via PSTN 101 and provides the ability for users to place and receive calls within communication system 100.

MSC 103 connects PSTN 101 to the wireless communication system serviced by MSC 103. MSC 103 is preferably responsible for compiling call information for billing and handing off calls from one cell to another. In an exemplary embodiment, MSC 103 is a CDMA MSC. MSC 103 provides control for base stations, such as base station 105. It should be understood that in a typical wireless communication system, MSC 103 would control a plurality of base stations, although FIG. 1 depicts only one base station for clarity.

Base station 105 is responsible for communicating over the air with mobile units that are located within a cell area covered by base station 105. Base station 105 completes calls with PSTN 101 utilizing MSC 103. In the exemplary embodiment depicted in FIG. 1, base station 105 is communicating over the air with mobile unit 115. It should be understood that, although FIG. 1 only depicts one mobile unit 115, a typical wireless base station services a plurality of wireless units at one time. In an exemplary embodiment, base station 105 is a CDMA base station and mobile unit 115 is a CDMA mobile unit.

Message server 107 is a server that provides messaging service to subscribers. In an exemplary embodiment, message server 107 is a voice message server that records and plays voice mail messages left in a mailbox associated with a subscriber, such as mobile unit 115. Message server 107 can be any server that provides messaging services to a subscriber, and can utilize voice, video, text, or any appropriate media. Although depicted in FIG. 1 as a standalone element, message server 107 can be incorporated into MSC 103.

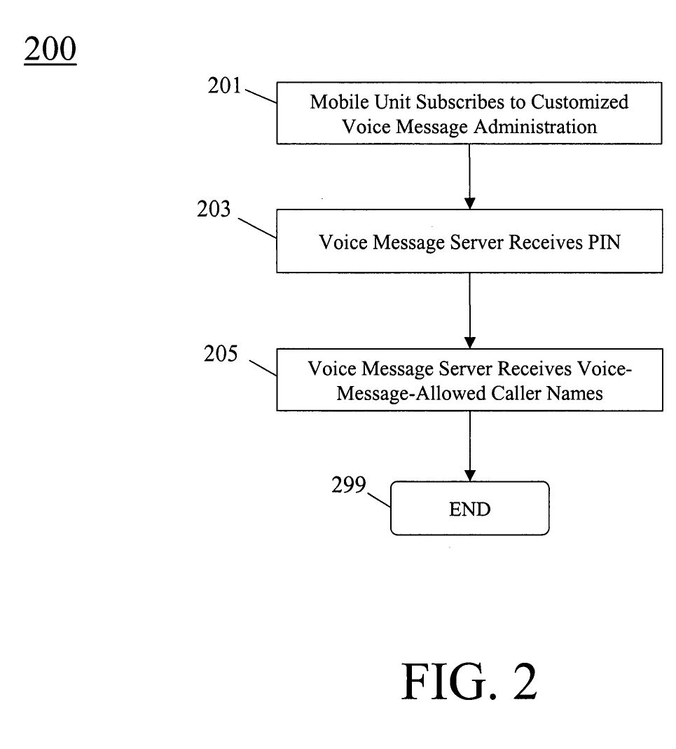

FIG. 2 depicts a flowchart 200 of a method for registering a mobile unit to a customized messaging service in accordance with an exemplary embodiment of the present invention.

Mobile unit 115 subscribes (201) to a customized voice message administration service. In an exemplary embodiment, the customized voice message administration service is optional feature that a subscriber can subscribe to for a fee.

Message server 107 receives (203) a personal identification number (PIN) from mobile unit 115. In an exemplary embodiment, the subscriber enters the PIN utilizing the keypad of mobile unit 115. In an alternate exemplary embodiment, the subscriber can enter the PIN utilizing a speech-to-text converter or can verbally convey the PIN to an operator who keys the PIN into message server 107 for mobile unit 115.

As an example of usage, the user of mobile unit 115, after setting a PIN on message server 107, can share the PIN with others. Those who know the PIN will be able to use the PIN to access message server 107 and the PIN will allow them to leave a message for the user of mobile unit 115.

Message server 107 receives (205) a list of message-allowed caller names from mobile unit 115. In an exemplary embodiment, the user of mobile unit 115 speaks the names of callers who are allowed to leave voice mail messages. In alternate exemplary embodiments, the user of mobile unit 115 can enter the names via a keypad on mobile unit 115 or can provide the names to the service provider, who enters and stores the names.

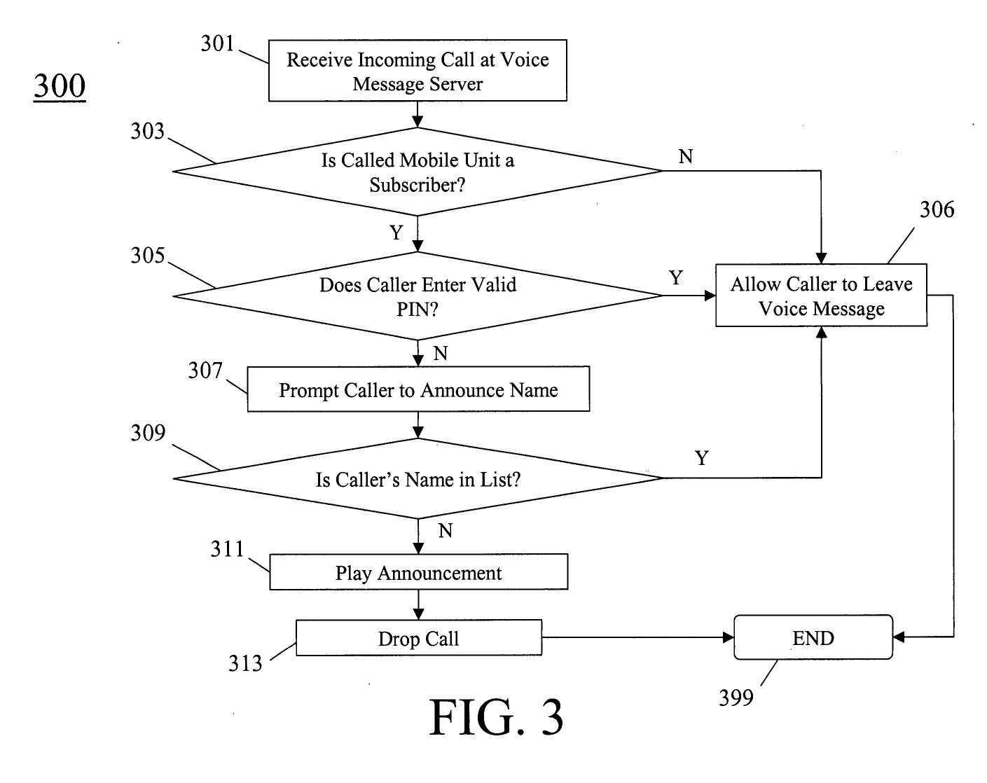

FIG. 3 depicts a flowchart 300 of a method for processing a call request by a message server in accordance with an exemplary embodiment of the present invention. In this exemplary embodiment, a call request has come in for mobile unit 115 while mobile unit 115 is unavailable. For instance, mobile unit 115 may be involved in another call, may be powered off, may be out of a usable service area, or the call request may simply be being ignored. In an exemplary embodiment, mobile unit 115 is roaming, but mobile unit 115 can also be located within its home communication system.

A call request for mobile unit 115 is received at MSC 103. After determining that mobile unit is not answering the call request, MSC 103 sends a message to message server 107. Message server 107 receives (301) the incoming call message from MSC 103.

Message server 107 determines (303) if the called mobile unit, mobile unit 115, subscribes to the customized voice message administration service. If mobile unit 115 does not subscribe to the service, message server 107 allows (306) the caller to leave a message in a mailbox associated with mobile unit 115.

If mobile unit 115 has subscribed to the customized voice message administration service as determined at step 303, message server 107 prompts the caller to enter a PIN via MSC 103 and determines (305) if the entered PIN matches a stored PIN associated with mobile unit 115. The PIN is preferably the PIN received by message server 107 at step 203.

If the caller enters a PIN matching the PIN of mobile unit 115, message server 107 allows (306) the caller to leave a message in a mailbox associated with mobile unit 115.

If the caller does not enter a valid PIN as determined at step 305, message server 107 prompts (307) the caller to announce their name via MSC 103. In an alternate exemplary embodiment, step 305 can be skipped and the caller can be brought directly to step 307 after determining that mobile unit 115 has subscribed to the customized voice message administration service as determined at step 303. In a further exemplary embodiment, the step of entering a PIN can occur after the step of prompting the caller to announce their name.

Upon receiving the caller's name, message server 107 determines (309) if the caller's name is in the message-allowed caller names list. In an exemplary embodiment, message server 107 receives the spoken name of the caller and performs a speech-to-text conversion on the received name. Message server 107 then compares the text version of the received name to each of the names in the list of message-allowed caller names received at step 205.

If the caller's name is in the list, indicating that mobile unit 115 has allowed this caller to leave a message in their mailbox, message server 107 allows (306) the caller to leave a message in the mailbox associated with mobile unit 115.

If the caller's name is not in the message-allowed caller names list as determined at step 309, message server 107 plays (311) an announcement to the caller. In an exemplary embodiment, the announcement communicates to the caller that the caller is not allowed to leave a message in the mailbox associated with mobile unit 115. After playing the announcement to the caller, message server 107 informs MSC 103 to drop (313) the call, and the process ends (399).

While this invention has been described in terms of certain examples thereof, it is not intended that it be limited to the above description, but rather only to the extent set forth in the claims that follow.

We claim:

1. A method for determining if a caller is allowed to leave a message in a mailbox, the method comprising:
determining if a caller has entered a valid personal identification number; and
if the caller has entered a valid personal identification number, allowing the caller to leave a message in a mailbox.

2. A method for determining if a caller is allowed to leave a message in a mailbox in accordance with claim 1, the method further comprising the step of, if the caller has not entered a valid personal identification number, dropping the call request.

3. A method for determining if a caller is allowed to leave a message in a mailbox in accordance with claim 2, the method further comprising the step of, prior to dropping the call request, playing an announcement to the caller.

4. A method for determining if a caller is allowed to leave a message in a mailbox, the method comprising:
prompting the caller to announce the name of the caller;
determining if the name of the caller is in a list of pre-approved names; and
if the name of the caller is in a list of pre-approved names, allowing the caller to leave a message in a mailbox.

5. A method for determining if a caller is allowed to leave a message in a mailbox in accordance with claim 4, the method further comprising the step of, if the name of the caller is not in the list of pre-approved names, dropping the call request.

6. A method for determining if a caller is allowed to leave a message in a mailbox in accordance with claim 5, the method further comprising the step of, prior to dropping the call request, playing an announcement to the caller.

7. A method for determining if a caller is allowed to leave a message in a mailbox in accordance with claim 4, the method further comprising the step of performing a speech-to-text conversion on the name of the caller.

8. A method for permitting access to a mailbox of a called phone, the method comprising:
receiving a call request for a called phone from a caller at a message server;
determining if the called phone has subscribed to a message administration service;
if the called phone has subscribed to a message administration service, determining if the caller is allowed to leave a message in a mailbox; and
if the caller is allowed to leave a message in a mailbox, permitting the caller access to the mailbox of the called phone.

9. A method for permitting access to a mailbox of a called phone in according with claim 8, wherein the step of determining if the caller is allowed to leave a message in a mailbox comprises determining if the caller has entered a valid personal identification number.

10. A method for permitting access to a mailbox of a called phone in according with claim 8, wherein the step of determining if the caller is allowed to leave a message in a mailbox comprises determining if the name of the caller is in a list of pre-approved names.

11. A method for permitting access to a mailbox of a called phone in according with claim 8, wherein the step of determining if the called phone has subscribed to a message administration service comprises determining if the message administration service has been activated.

12. A method for permitting access to a mailbox of a called phone in according with claim 11, wherein the step of activating the message administration service comprises automatically activating the message administration service based upon a predetermined event.

13. A method for permitting access to a mailbox of a called phone in according with claim 12, wherein the predetermined event is roaming.

14. A method for permitting access to a mailbox of a called phone in according with claim 11, the method further comprising the step of deactivating the message administration service.
